(19) United States
(12) Patent Application Publication
(10) Pub. No.: US 2010/0141550 A1
(43) Pub. Date: Jun. 10, 2010

(54) ANTENNA MODULE, METHOD FOR MAKING THE ANTENNA MODULE, AND HOUSING INCORPORATING THE ANTENNA MODULE

(75) Inventor: ZHAN LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/556,236

(22) Filed: Sep. 9, 2009

(30) Foreign Application Priority Data
Dec. 5, 2008 (CN) 200810306002.8

(51) Int. Cl. H01Q 1/38; H01Q 1/42; B32B 37/14

(52) U.S. Cl. 343/872; 343/700 MS; 156/60

(57) ABSTRACT

An antenna module includes, a carrying layer made of resin, at least one dielectric layer, and at least two antenna layers, one of the antenna layers attached to the carrying layer. The dielectric layer and the antenna layers are alternately laminated on each other. The invention also discloses a method for making the antenna module, and a housing integrating the antenna module.

### BACKGROUND

1. Technical Field

The present disclosure relates to an antenna module, a method of manufacturing the antenna module and a housing of a portable electronic device having the antenna module.

2. Description of Related Art

Portable electronic devices, such as mobile phones, personal digital assistants (PDAs) and laptop computers are widely used. Most of these portable electronic devices have antenna modules for receiving and sending wireless signals.

Referring to FIG. 3, a related antenna module used in a portable electronic device is provided. The antenna includes an outer layer 91, an antenna layer 92, an inner layer 93, a conductive terminal 94, a printed circuit board (not shown), and a conductive post 95 connecting to the printed circuit board. The outer layer 91 is a plastic film for supporting the antenna layer 92. The antenna layer 92 is attached to and located between the outer layer 91 and the inner layer 93. The conductive terminal 94 electrically contacts the antenna layer 92 and extends to connect to the conductive post 95.

However, the antenna module only has one antenna layer 92 to realize one function. To realize multifunction, the portable electronic device should have a plurality of antenna modules. However, such structure would inevitably enlarge the antenna module accommodated in the portable electronic device.

Therefore, there is a room for improvement within the art.

### BRIEF DESCRIPTION OF THE DRAWINGS

Many aspects of an antenna module, method for making the antenna module, and housing integrating the antenna can be better understood with reference to the following drawings. The components in the drawings are not necessarily to scale, the emphasis instead being placed upon clearly illustrating the antenna module, method for making the antenna module, and housing integrating the antenna. Moreover, in the drawings, like reference numerals designate corresponding parts throughout the several views.

FIG. 1 is a cross-sectional view of an antenna module, according to an exemplary embodiment.

FIG. 2 is a cross-sectional view of a housing, according to the exemplary embodiment.

FIG. 3 is a cross-sectional view of a typical portable electronic device.

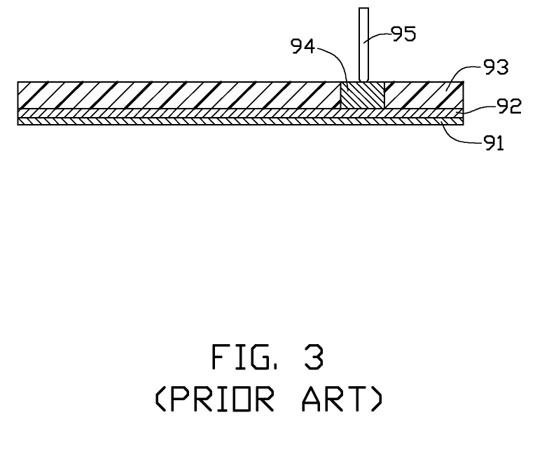

### DETAILED DESCRIPTION OF THE EMBODIMENTS

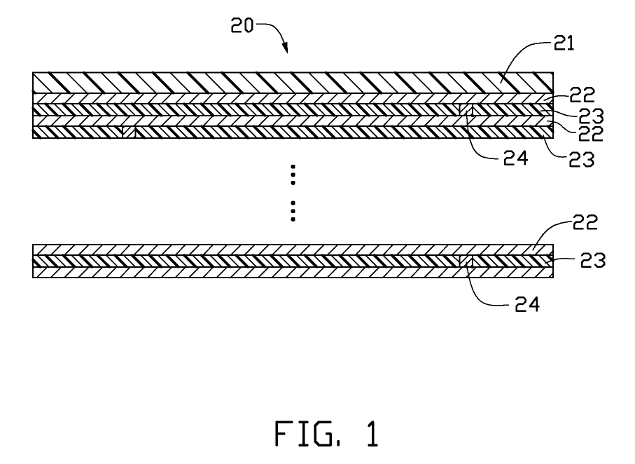

FIG. 1 shows an antenna module 20 including a carrying layer 21, a plurality of antenna layers 22, and a plurality of dielectric layers 23.

The carrying layer 21 can be made of a resin material selected from a group consisting of polycarbonate (PC), acrylonitrile-butadiene-styrene (ABS), and polyethylene terephthalate (PET), etc.

Each of the antenna layers 22 can be a printed conductive ink film. Each of the antenna layers 22 has an antenna pattern formed thereon.

The dielectric layers 23 can be printed dielectric ink films. The dielectric layers 23 are respectively positioned between each two contiguous antenna layers 22. A plurality of conductive portions 24 are formed within the plurality of dielectric layers 23 respectively. Each of the conductive portions 24 has two ends respectively connect to two adjacent antenna layers 22. The conductive portion 24 can be made of conductive ink.

When the antenna module 20 is manufactured, the antenna patterns are printed on the carrying layer 21. One of the antenna layers 22 is formed on the carrying layer 21. Dielectric ink can be partially printed on the one antenna layer 22 to form the dielectric layer 23. Thus, the one antenna layer 22 is partially exposed from one side of the dielectric layers 23. The conductive ink further can be printed on an opposite side of the dielectric layer 23 to form another antenna layers 22 electrically connecting to the one antenna layer 22. The conductive portion 24 is the conductive ink electrically connecting the one antenna layer 22 to the another antenna layer 22. The dielectric layers 23 and the antenna layers 22 are alternately laminated to form the antenna module 20.

It is to be understood that the dielectric layers 23 can be made of a dielectric resin, and the dielectric layers 23 can be attached (for example sprayed) to the antenna layers 22.

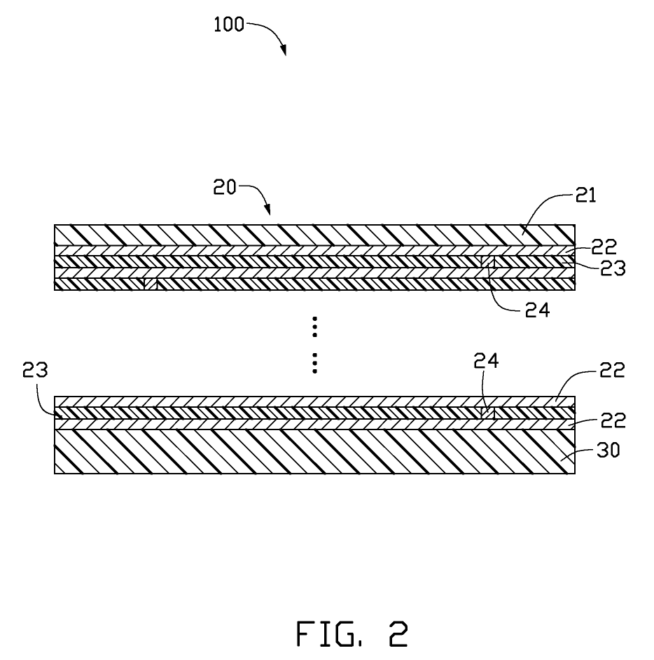

Referring to FIG. 2, the antenna module 20 can be directly integrally formed within a housing 100 of a portable electronic device. The housing 100 includes an injection layer 30 and the antenna module 20. The injection layer 30 is made of a resin injection molded to the antenna module 20.

When manufacturing the housing 100, the antenna module 20 is received in an injection mold. The carrying layer 21 is attached to the bottom of injection mold. The injection layer 30 is molded to the antenna layer 22 opposite to the carrying layer 21.

It is to be understood the injection layer 30 can alternatively be attached to the dielectric layer 23 opposite to the carrying layer 21. Accordingly, the antenna layer 22 may be protected by the dielectric layer 23.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna module, comprising:
a resin carrying layer;
at least one dielectric layer; and
at least two antenna layers, one of the antenna layers attached to the carrying layer;
wherein the dielectric layer and the antenna layers are alternately laminated on each other.

2. The antenna module as claimed in claim 1, wherein the antenna layers are made of conductive ink.

3. The antenna module as claimed in claim 2, wherein a conductive portion is made of conductive ink formed between the two antenna layers, the conductive portion electrically connects to two antenna layers.

4. The antenna module as claimed in claim 1, wherein the dielectric layer is made of dielectric ink.

5. The antenna module as claimed in claim 1, wherein the dielectric layer is made of dielectric resin.

6. The antenna module as claimed in claim 1, wherein the carrying layer is selected from a group consisting of polycarbonate, acrylonitrile-butadiene-styrene, and polyethylene terephthalate.

7. A method for making an antenna module, comprising:
providing a carrying layer;
providing at least one dielectric layer; and;
providing at least two antenna layers, one of the antenna layers attached to the carrying layer;
wherein the dielectric layer and the antenna layers are alternately laminated on each other.

8. The method for making an antenna module as claimed in claim 7, wherein the dielectric layer is made of dielectric ink.

9. The method for making an antenna module as claimed in claim 7, wherein the dielectric layer is made of dielectric resin.

10. The method for making an antenna module as claimed in claim 7, wherein the dielectric layer is partially printed on one of the antenna layers, the on one of the antenna layers is partially exposed from the dielectric layer, the other one of the antenna layers is formed on the dielectric layer, and connects to the one of the antenna layers exposed from the dielectric layer.

11. A housing, comprising:
an antenna module comprising:
a resin carrying layer;
at least one dielectric layer;
at least two antenna layers, one of the antenna layers attached to the carrying layer; the dielectric layer and the antenna layers are alternately laminated on each other; and
an injection layer attached to the antenna module.

12. The housing as claimed in claim 11, wherein the injection layer is attached to the dielectric layer opposite to the carrying layer.

13. The housing as claimed in claim 11, wherein the injection layer is attached to the antenna layer opposite to the carrying layer.
